(19) United States
(12) Patent Application Publication
(10) Pub. No.: US 2005/0217127 A1
(43) Pub. Date: Oct. 6, 2005

(54) Measurement device and method for determining the three-dimensional orientation of a body relative to two horizontal reference directions

(75) Inventor: Michael Hermann, Villingen (DE)

Correspondence Address: NIXON PEABODY, LLP, 401 9TH STREET, NW, SUITE 900, WASHINGTON, DC, 20004-2128, US

(73) Assignee: Prueftechnik Dieter Busch AG, Ismaning (DE)

(21) Appl. No.: 10/817,432

(22) Filed: Apr. 5, 2004

(51) Int. Cl. G01C 9/10

(52) U.S. Cl. 33/365

(57) ABSTRACT

The determination of the three-dimensional orientation of a body relative to two horizontal reference directions with increased accuracy is performed by an inclinometer-based elevation measurement device which has at least three, and preferably eight individual inclinometers. The individual inclinometers are positioned relative to a housing of the measurement device in such a manner that they point in different directions in space and each combination of three individual inclinometers combines to form a triad for computationally determining the measured orientation values of the body in a first step. Thereafter, in second step, the measured orientation values are combined in a weighted or unweighted form to produce an overall measured value of the body having substantially higher precision.

### BACKGROUND OF THE INVENTION

1. Field of the Invention

The invention relates to a measurement device for the precise determination of the three-dimensional orientation of a body relative to two horizontal reference directions, so that the determination both of a pitch angle and of a roll angle can be carried out in an improved and very accurate manner. In order to carry out the measurement, the body is mounted fixed in three dimensions and not moved; during the performance of the measurement on the body, at least only the acceleration due to gravity may act on said body. That is, the invention is not suitable for applications in the absence of gravity such as in space. Furthermore, the invention relates to at least one method for providing an overall measured result from individual measured results which are provided by inclinometer subsystems. In addition, the invention relates to the use of the measurement device for determining two components of the three-dimensional orientation of a machine and of machine elements, such as rollers or rolls, and for providing correction information in order to bring misaligned machines or machine elements into an aligned position, and also relates to the use of the measurement device for determining direction on other objects.

2. Description of Related Art

For the purpose of determining the three-dimensional orientation of a body relative to a reference direction, and absolutely within an inertial system, it has been known for some time to use accurate gyro systems. In addition to mechanical gyros, whose precision is limited by mechanical boundary conditions, optically based gyros, in particular in the embodiment with what is known as a ring laser, have been on the market for some time as highly accurate direction and orientation measurement devices. Such a device is disclosed by U.S. Pat. No. 6,195,615 which teaches a highly accurate optically based gyro system for the mutual alignment of bodies, in particular for shafts, rolls and the like. Unfortunately, the costs for particularly accurate instruments of this type are considerable, so that it is of significant interest to improve the cost/benefit relationship of such measurement devices considerably.

A method specified in published German Patent Application DE 42 05 869 is even still more complicated, since a double set of gyro systems is provided for the measurement.

The solution presented in U.S. Pat. No. 5,719,764 is extremely complicated. Initially, redundant control gyros and accelerometers are provided, which carry out a short-term and a long-term error estimation. Then, provision is made to connect two such systems together to form a double-secured device operating in a tandem composite arrangement.

A relatively inexpensive but less accurately functioning solution is disclosed by published German Patent Application DE 198 00 901, which, instead of optical gyros, provides alignment based on mechanical oscillators.

Published German Patent Application DE 198 30 359 discloses an apparatus and a method for determining the three-dimensional position and movements of a (human) body or parts of the body in which less strident requirements are placed on the accuracy of the measured results than on the availability of such data over time, that is to say the time resolution.

Published German Patent Application DE 199 49 834 discloses a method which permits the accuracy of the solution according to U.S. Pat. No. 6,195,615 to be increased considerably; however, the software complexity additionally is crucial although the outlay on apparatus can remain the same.

A further use of gyro-based direction measurement devices is presented in published German Patent Application DE 100 60 974. The device therein can be positioned on the ends of rolls by means of an adapter, and is additionally equipped with a laser-based position measuring apparatus.

Published U.S. patent application 2002/0165688, discloses the use of gyro-based direction measurement devices having more than three individual gyros which, for example, are mounted parallel to the normal or other lines of symmetry of a regular octahedron or icosahedron etc. This makes it possible to provide a device with improved measurement accuracy since it is possible to employ statistical methods (which are not possible in practice with only three individual gyros) and, furthermore, mutual checking of the individual gyros can also be carried out.

### SUMMARY OF THE INVENTION

The aforementioned discussion provides the basis of the present invention which solves the present problems in that a redundant design of a two-dimensional sensing direction measurement system equipped with inclinometers is set forth. The system of the invention has functional properties, both with regard to operational reliability and in particular also with regard to accuracy, which are improved. At the same time, the production costs of the overall system are reduced to the extent that less accurate and less expensive individual systems are used. In other words, instead of an inclinometer system comprising two individual inclinometers aligned orthogonally with respect to each other, the invention provides such a system which comprises at least three, preferably four or more individual inclinometers. These are preferably MEMS inclinometers which, although they cannot indicate the direction of an acceleration individually (as opposed to simple liquid inclinometers according to prior art FIGS. 3 and 4), are suitable for determining the magnitude of an associated acceleration component, as indicated in FIG. 5 by using the simple spring-load combination shown.

According to one embodiment of the invention, the solution of the fundamental problem can be provided by means of implementation of the basic arrangement discussed below.

The measurement device for determining the three-dimensional orientation of a body relative to two reference directions lying in a particular horizontal plane has a housing to be placed on a surface or on an edge of a body to be measured, and has a plurality of inclinometer systems for determining steady-state three-dimensional positions or of tilting or rotational movements relative to predefined inertial directions. There is provided at least three, and preferably four or more, individual inclinometers within the housing, whose respective reference or active directions are oriented in accordance with different directions in space in order to register a component of the acceleration due to gravity. The combination of three individual inclinometers are combined to form one inclinometer triad and form an inclinometer system supplying a respective first measured result, which indicates the three-dimensional angular orientation of the measurement device or of a body with which the latter makes contact in accordance with the (three-dimensionally fixed) directional coordinates of roll and pitch, such that a plurality of measured results of a first type can be determined. Further, from the measured results of the first type a measured result of the second type can be provided as the overall measured result, i.e., by means of averaging or other computational methods such as digital filtering, which indicates a more accurate angular orientation of the measurement device or a body in contact therewith, i.e., with regard to the directional coordinates of roll and pitch, as compared with individual measured results of the first type.

Another embodiment of the invention includes, for example, eight individual inclinometers arranged symmetrically about an axis or about a center. Irrespective of whether these are inexpensive or high-quality individual inclinometers, the combination of a large number of identical or even differently constructed individual inclinometers provides a disproportionately improved accuracy. This occurs since it is possible to compensate for temperature and gravitational effects by means of differentiation, averaging or other statistical considerations. In addition, by means of the invention, i.e., three-dimensional or in particular non-coplanar, arrangement of the individual sensors, better calculation bases are created for providing a measured result, so that an overall inclinometer system capable of functioning better than previously known two-dimensional arrangements can also be provided.

This is a particularly significant feature of the present invention. As an example, according to the invention, typically all combinations that can be used, i.e., non-coplanar combinations, of three inclinometers from a total of “k” individual inclinometer measured values can be used to form individual inclinometer measured value triads, in order to be able to carry out a plurality of independent directional measurements with the inclinometer triads. Since, in the case of the example of 3-8 inclinometers, a maximum of (n factorial k=) 56 individual evaluation measuring systems for the detection of an angular orientation of the measurement device in two coordinates in space can be represented, the accuracy of an overall measured result can be improved significantly with regard to drift. Additional errors can be reduced by means of averaging and other statistical considerations, or by means computational methods such as digital filtering.

At the same time, the plurality of measuring systems of the invention, including three individual inclinometers each, can be checked against one another, such that individual inclinometers with impaired measurement can be identified as early as during regular operation and, if necessary, can be stopped. The system according to the invention provides additional design redundancy, so that a measuring system of the type disclosed, that is, having at least 4 individual inclinometers, can nevertheless continue to be used in the event of failure of an individual inclinometer, although with reduced accuracy.

Therefore, according to the invention, a measurement device for determining the three-dimensional orientation of a body relative to two reference directions lying in a horizontal plane is provided which has a housing to be placed on a surface of a body to be measured, within which housing a plurality of individual inclinometers for determining a proportional value of the acceleration due to gravity with respect to relative axes of symmetry associated with the individual inclinometers is provided. The measurement device of the invention is distinguished by the fact that there are at least three, but preferably four or more, individual inclinometers within the housing which are oriented or aligned in a non-coplanar fashion in respectively different spatial directions. All combinations of three individual inclinometers, which are orientated in a non-coplanar fashion, can be combined to form an inclinometer triad for supplying a first measured result which indicates the three-dimensional angular orientation of the measurement device or of a body in contact therewith in accordance with the two three-dimensional coordinates “roll” and “pitch”. This arrangement of the invention is used in such a manner that, initially, a large number of measured results of the first type are provided and then, from the large number of measured results of the first type, an overall measured result (that is to say a measured result of the second type) is determined. When compared with the individual measured results of the first type, the second type measurement indicates a significantly more accurate angular orientation of the measurement device or body in contact therewith.

According to another aspect of the invention, from the large number of measured results of the first type, and in conjunction with a suitable mathematical algorithm, such as SVD (singular matrix decomposition), a significantly more accurate measured result can also be provided immediately.

The number, e.g., eight, individual inclinometer systems within an overall system according to the invention is to be understood only as an example. It is also possible to use, for example, four, five, six inclinometers or a substantially larger number, for example 150 to 400 miniaturized elements of this type, in particular those whose output signal varies substantially sinusoidally over the pitch and roll angles or which can be compensated appropriately by using a correction value table. The selected number of individual inclinometers should, however, lead to a compromise with regards to cost of the apparatus versus an achievable increase in accuracy. As can be seen, such a compromise also depends on what proportion of cost has to be estimated for a requisite additional computing unit for calculating the desired overall result. For the very small-construction, extremely low-power and very inexpensive MEMS inclinometers (which are relatively inexpensive), it appears advantageous according to the invention to combine about 150 individual inclinometers to form an overall system. For reasons of easier data processing, the individual inclinometers should preferably provide a pulse code modulated output signal. In this way, it is possible to avoid multiplexing or the use of a large number of conventional analog-digital converters. This is best done in a conventional manner by using conventional digital timer/counter components, specifically by using commercially available miniaturized precision timers with accuracies of in the region of at least 10⁶ or better.

According to an embodiment of the invention, the group of individual systems are provided symmetrically about a single preferred axis. Further, individual systems can be orientated or distributed in accordance with the directions of symmetry of a regular polyhedron or approximately statistically over the three-dimensional angle (4*π). However, it should be ensured that the individual orientations of the individual systems are mounted sufficiently firmly with respect to a coordinate system fixed to the device and also experience only low thermally induced directional changes within the housing.

In the system of the invention, construction of the housing must also be sufficiently dimensionally stable. Additionally, it is important that the directional vectors respectively assigned to three individual inclinometers are not located in a coplanar fashion in space. According to the invention, the measured values which are determined by the individual inclinometers, typically in an oblique-angle, three-dimensional coordinate system, are converted to a rectangular Cartesian coordinate system. The computational methods for such a conversion are known. In this way, measured values that are output can be expressed, for example, in two of the three Euclidean angles (namely the pitch and roll angles) with respect to such a rectangular coordinate system. Provision of a measured value for the yaw angle by means of inclinometers alone is not possible. The aforementioned conversion, just like the statistical calculations, is carried out by a computer provided in an enclosing housing of the measurement device. In order to save supply power, the computer clock frequency can be reduced as soon as it can be seen that no measurement is currently to be carried out. This can be based, for example, on the fact that a sensed three-dimensional position of the device according to the invention does not change and can be assumed to be stable.

These and further details of the invention will be explained using the accompanying drawings.

### BRIEF DESCRIPTION OF THE DRAWINGS

FIG. 1 is a perspective view of an axially symmetrical arrangement of 7 individual inclinometers relative to an x-y-z coordinate system;

FIG. 2 is a diagrammatic representation of the configuration of a system having 7 individual inclinometers;

FIG. 3 shows a conventional liquid inclinometer (spirit level);

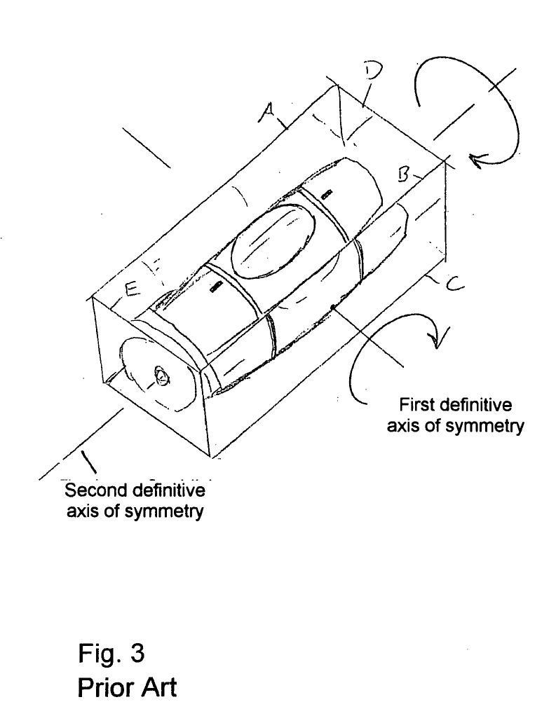

FIG. 4 shows another conventional spirit level;

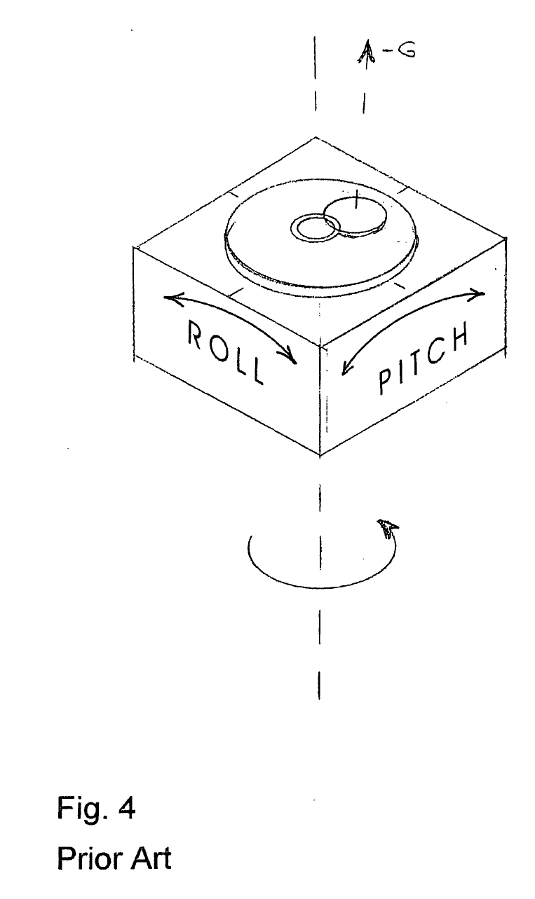

FIG. 5 shows a mechanical inclinometer, shown as a model, for registering a vertically oriented gravitational component;

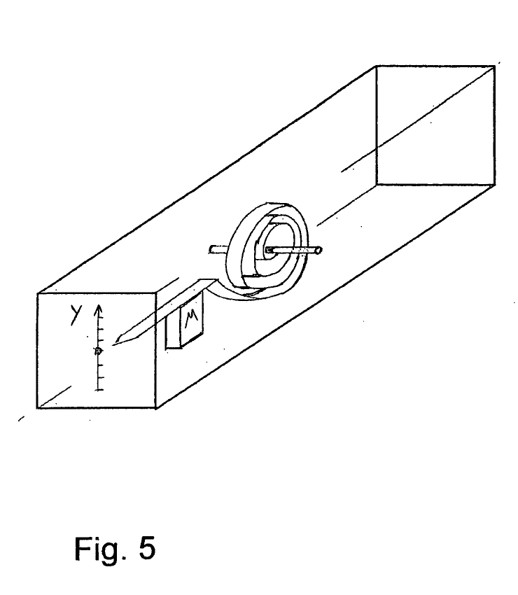

FIG. 6 shows an arrangement of inclinometer of the corner(s), side(s) and center(s) of a dodecahedron.

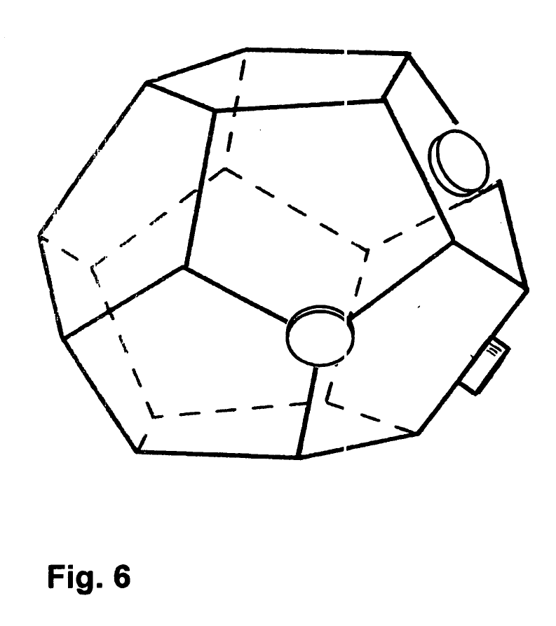

FIG. 7 shows an arrangement of inclinometer of the corner(s), side(s) and center(s) of an octahedron.

### DETAILED DESCRIPTION OF THE INVENTION

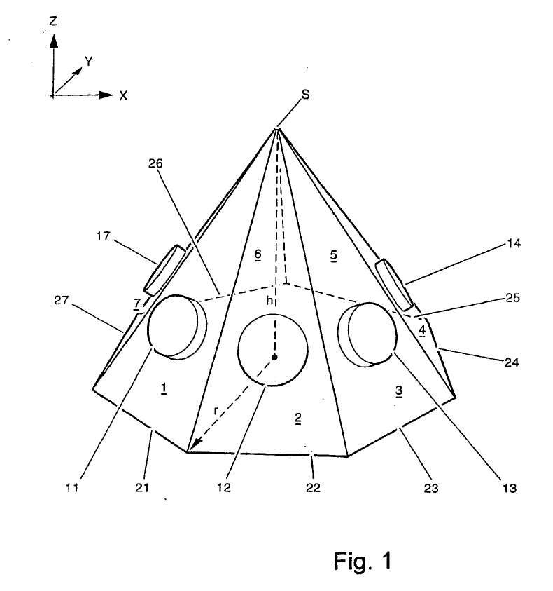

As can be seen from FIG. 1, defined directions for the housing of a measurement device of the type presented here with respect to a predefined x-y-z coordinate system fixed to the device are defined, for example, by a pyramid. The side faces 1, 2, 3, 4, 5, 6 and 7 have a common corner S and base edges 21, 22, 23, 24, 25, 26 and 27, which bound the base face of the pyramid. The individual side faces therefore differ unambiguously in their direction cosine values. On an individual side face (1 to 7), in each case an individual, for example, micromechanical or thermodynamically functioning, inclinometer is placed (11, 12, 13, 14, 17); the remaining individual inclinometers are not shown for reasons of clarity).

An individual inclinometer can be identified with respect to its own coordinate system by means of at least one vector which, in each case, defines a system-induced active direction. This can be, for example or preferably, a normal vector, which then lies perpendicular or possibly parallel to the relevant side face of the pyramid. Thus, the directional cosine values or other direction-characteristic values that can be used for the specification of a definitive reference direction of the individual inclinometers relative to the x-y-z coordinate system shown can be specified accurately. By means of a combination of, in each case, three arbitrarily selected inclinometers (triads), a rotational or tilting movement of the coordinate system fixed to the device can thus be measured with respect to two axes in space. Following conversion, the measured result can be presented in the form of pitch and roll values. The assumption is that the aforementioned reference directions of the individual inclinometers are not coplanar in pairs. To this extent, the accuracy to be expected of the triads which can be represented individually from FIG. 1 is not equivalent, instead certain combinations are distinguished by higher accuracy than, for example, a triad of directly adjacent inclinometers 11, 12, 13.

Since, in the configuration depicted, a total of 35 mutually independent inclinometer triads can be specified, the observation of the aforementioned rotational or tilting movement, consequently also the measurement of the relative position of a body with respect to two horizontal reference directions, relates to 35 individual measurements. In the ideal case, all individual measurements would supply the same result. However, as already explained, the individual configurations operate with different accuracy. The individual measurements are preferably combined to form an overall value and positioned in such a way that the inclinometer triads that operate more accurately are provided with a higher weight during averaging to be carried out. For more accurately functioning inclinometer triads those whose spacings are not less than two positions removed should be used. Typically, those inclinometer triads whose inclinometers are adjacent, that is to say have no interspaces and whose reference directions cover only a small-volume parallel-piped, provide measurements that are least accurate.

In order to achieve a good measured result, in the arrangement shown, the ratio between the height h and the radius r of a basic pyramidal body should have approximately a value of 0.2 to 1.2, and preferably the value is around 0.55. In the case of an approximately twofold use of material, as compared with a conventional two-dimensional inclinometer arrangement, according to the invention a result many times, e.g., 3-4 times, more accurate can be obtained. The sense and the substantial advantage of the invention resides in providing a multiply redundant inclinometer system, whose accuracy increases disproportionately with respect to the material used. An additional advantage of the invention resides in the fact that measurement devices of the generic type, such as the type used for measuring rolls in paper and rolling mills, can be used. Such types are of an elongated shape and therefore provide space for a relatively large number of individual inclinometer systems with an extremely different alignment relative to the housing of the measurement device.

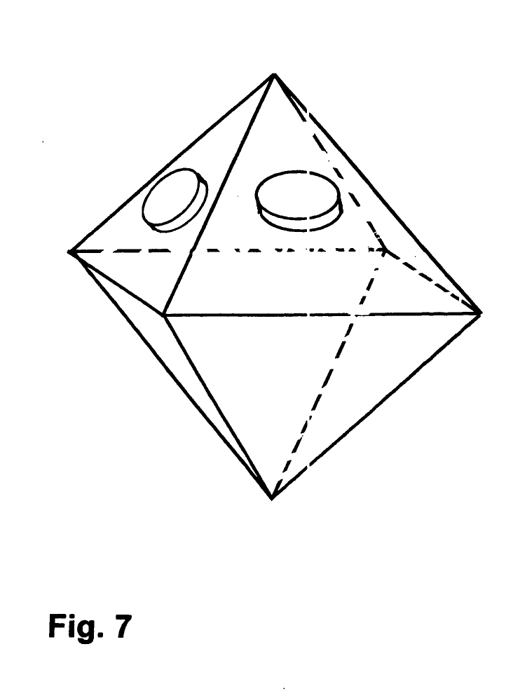

In a preferred embodiment of the invention shown in FIG. 7, eight individual inclinometers are located on the faces of a regular octahedron (in general: k individual inclinometers parallel or normal to the faces, sides, bisectors of the sides and/or corners of a regular polyhedron), with only two inclinometers being illustrated for simplicity. Given such an arrangement, the directional differences between the individual inclinometers are on average greater than in the arrangement shown in FIG. 1. Furthermore, the calculation of the different inclinometer combinations is simplified due to the properties of symmetry, so that such an arrangement operates even more efficiently. That is, with little increased expenditure on material, this embodiment supplies a further improved measured result.

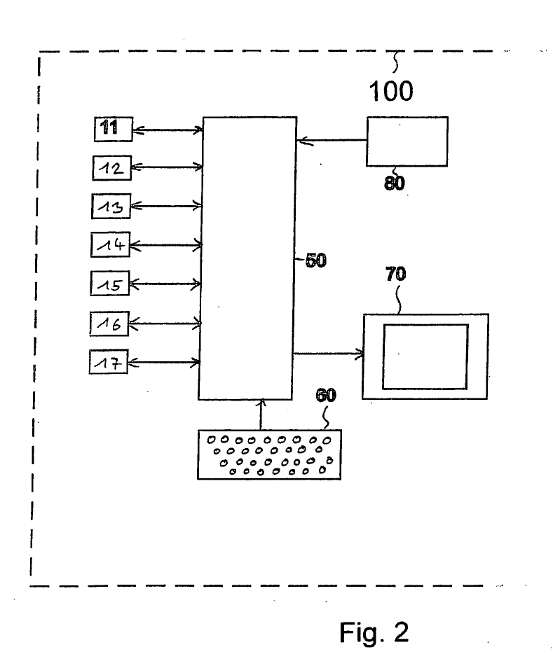

The schematic drawing of FIG. 2 shows how an overall system according to the invention is assembled from a housing 100, individual inclinometers 11 through 17 arranged in this housing, a computer 50 for polling the signals output by the inclinometers and for determining a result in the form of an orientation value. This result can be displayed on a monitor 70. The operation of the overall system is preferably carried out by means of a keyboard 60, although other input means (mouse, trackball, pen, speech and so on) can be provided. The overall system is preferably powered by a battery or rechargeable battery 80 or, if necessary, a main power connection can also be provided.

This embodiment can operate on its own. However, it is used with particular advantage in interaction with a similarly operating combination of gyroscopes, specifically MEMS gyroscopes including thermodynamically operating gyroscopes, which are arranged within a common housing. As is known with such a gyroscope mechanism, it is then possible to measure the inclination values of pitch and roll and in addition to register the azimuthal value “yaw”. However, the aforementioned inclination and azimuthal values are afflicted by disruptive drift errors.

The inclinometer device presented in accordance with the present invention operates statically; its drift over time is substantially lower than in the case of a gyroscope. If, as is possible when measuring rolls or other rotatable cylinders, a combination of inclinometers and gyroscopes can temporarily be fixed, as elements 11-14,17 of FIG. 1, again and again for a while (and then registers the magnitude and direction of the acceleration due to gravity in a precise way), the two components of roll and pitch of the gyroscope values can be corrected, that is to say “supported”, by the respective components of the inclinometer values. In this way, an estimate can additionally be made as to the extent to which the yaw value provided by the gyroscopes can be traced back to a supposed best value.

In the mechanical rest state, therefore, the measurement device is intended to equate a current gyroscope-based directional measured result with respect to its azimuthal (yaw) rotational movement to a supposed best value in the shortest possible time by using current inclinometer-based roll and pitch directional measured results, the supposed best value being calculated by using a predefined or adaptable algorithm. The aforementioned adaptation can be carried out, for example, by using temperature measurements on the individual sensors or within the device, or by using an estimated quality value for a measurement carried out. Using this, a significant improvement in the aforementioned gyroscope-based directional measurement is therefore achieved, e.g., typically by at least one order of magnitude. With more accurate instruments of the aforementioned type, it therefore becomes possible to determine the influence of the rotation of the Earth on the measured result and to use this additional measured result to correct the desired measured result. This special compensation is intrinsically already standard in the highest-quality, optically functioning gyroscopes.

Including or without the optional implementation of the abovementioned gyroscopes, the invention is preferably used in the measurement of buildings, of machine tools, or of machines which are used for the production or processing of metal, paper or plastic films. Furthermore, the invention is used with quite particular advantage in equipment used for oil prospecting or oil supply.

1. A measurement device which includes a plurality of inclinometer systems for determining steady-state, three-dimensional positions relative to a predefined inertial direction and for determining the three-dimensional orientation of a body relative to two reference directions lying in a horizontal plane comprising:
a housing adapted for placement on a surface or edge of the body to be measured;
a least three individual inclinometers on or within the housing each positioned in respective reference directions so as to be oriented in different directions in space relative to each other in order to register a component of acceleration due to gravity; and
a computation device,
wherein a combination of three individual inclinometers combine to form one inclinometer triad supplying a respective first measured result which indicates the three-dimensional angular orientation of the measurement device with the directional coordinates of roll and pitch such that a plurality of measured results of a first type can be determined, and
wherein the computation device is adapted for determining a measured result of a second type from the measured results of the first type, the measured result of a second type being an overall measured result which indicates another angular orientation of the measurement device with regard to the directional coordinates of roll and pitch.

2. The measurement device as claimed in claim 1, wherein at least four inclinometers are provided on or within the housing.

3. The measurement device as claimed in claim 1, wherein the computation device has means for performing an averaging method on the plurality of measured results of the first type to achieve the measured result of the second type.

4. The measurement device as claimed in claim 1, wherein the different reference directions relate to a point of symmetry and substantially correspond to the directions perpendicular to surfaces of a regular polyhedron.

5. The measurement device as claimed in claim 4, wherein the regular polyhedron is one of a tetrahedron, an octahedron and a dodecahedron.

6. The measurement device as claimed in claim 1, wherein the different reference directions relate to a line in space and substantially correspond to directions which are defined by perpendiculars of side faces of an at least four-sided pyramid.

7. The measurement device as claimed in claim 1, wherein the different reference directions relate to a line in space and substantially correspond to directions which are defined by perpendiculars of side faces of an at least three-sided pyramid.

8. The measurement device as claimed in claim 4, wherein there are eight individual inclinometers each of which has definitive reference directions that are aligned parallel to one of surface perpendiculars, edges of the polyhedron, corner radii of the polyhedron or edge center radii of the polyhedron.

9. The measurement device as claimed in claim 1, including a gyroscope-based directional measurement device for providing confirmation of the measured results of the first and second type with respect to a roll coordinate and a pitch coordinate.

10. The measurement device as claimed in claim 9, in which, when the measurement device is in a mechanical rest state, the current gyroscope-based directional measured result is equivalent to the azimuthal (yaw) rotational movement as a best value in the shortest possible time employing the inclinometer-based roll and pitch directional measured results, wherein the best value is calculated by a predefined or adaptable algorithm.

11. The measurement device as claimed in claim 1, in which the overall measured result is determined by a weighted average and by using a weighting criteria.

12. A method of providing an accurate position value when determining the three-dimensional orientation of a measurement device or of a body in contact with the measurement device comprising:
a first measurement step of obtaining all usable directional information by means of measurement values acquired from combinations of three inclinometers from a total of “k” individual inclinometers present on or in the measurement device; and
a second measurement step of computing an overall measured result by means of statistical algorithm from the usable directional information of the first measurement step,
wherein “k” is at least three individual inclinometers positioned in respective reference directions so as to be oriented in different directions in space relative to each other in order to register a component of acceleration due to gravity.

13. A machine for the production or processing of paper, metal or plastic films comprising the measurement device of claim 1.

14. A machine tool comprising the measurement device of claim 1.

15. A method of prospecting for or supplying oil wherein directional information for the apparatus for prospecting or supplying oil is determined by the method of claim 12.

16. A method for measuring buildings or structure wherein directional information for the building or structure is determined by the method of claim 12.
